(19) United States
(12) Patent Application Publication
(10) Pub. No.: US 2011/0210480 A1
(43) Pub. Date: Sep. 1, 2011

(54) Nanostructures with anti-counterefeiting features and methods of fabricating the same

(75) Inventor: Boris Kobrin, Dublin, CA (US)

(73) Assignee: ROLITH, INC, Dublin, CA (US)

(21) Appl. No.: 13/066,473

(22) Filed: Apr. 14, 2011

Related U.S. Application Data
(63) Continuation-in-part of application No. PCT/US2008/012901, filed on Nov. 18, 2008.
(60) Provisional application No. 61/342,592, filed on Apr. 17, 2010.

(51) Int. Cl. B29C 59/16

(52) U.S. Cl. 264/447

(57) ABSTRACT

Embodiments of the invention relate to methods of anti-counterfeiting for nanostructures and nanostructured devices. Specifically we describe a method of embedding a coded micro- or nanopatterns in nanostructures fabricated using Near-field rolling mask lithography, where areas of such features can be embedded into a transparent cylindrical or conic frame, or fabricated on the surface of flexible film laminated on the surface of the frame. Alternatively, specific coded nanofeatures distribution can be created using modulation of intensity or wavelength of the light source along the width or length of such cylinder or cone, or modulation of flexible film thickness or contact pressure between the rotatable mask and a substrate.

### FIELD

Embodiments of the invention relate to nanostructures fabrication, especially methods of protecting nanostructured devices from counterfeiting

### BACKGROUND

This section describes background subject matter related to the disclosed embodiments of the present invention. There is no intention, either express or implied, that the background art discussed in this section legally constitutes prior art.

Nanostructuring is necessary for many present applications and industries and for new technologies which are under development. Improvements in efficiency can be achieved for current applications in areas such as solar cells and LEDs, next generation data storage devices, architectural glass and bio- and chemical sensors, for example and not by way of limitation.

Nanostructured substrates may be fabricated using techniques such as e-beam direct writing, Deep UV lithography, nanosphere lithography, nanoimprint lithography, near-field phase shift lithography, and plasmonic lithography, for example.

Earlier authors have suggested a method of nanopatterning large areas of rigid and flexible substrate materials based on near-field optical lithography described in Patent applications WO2009094009 and US20090297989, where a rotatable mask is used to illuminate specific areas of a radiation-sensitive material. Typically the rotatable mask comprises a cylinder or cone. The nanopatterning technique makes use of Near-Field photolithography, where the mask used to pattern the substrate is in contact with the substrate. The Near-Field photolithography may make use of an elastomeric phase-shifting mask, or may employ surface plasmon technology, where a rotating cylinder surface comprises metal nano holes, nanoparticles or other nanostructures.

Variety of new advanced products based on nanostructuring of surfaces can be manufactured using the nanopatterning techniques described above, especially when those techniques are scaled up to conveyor type systems capable of nanofabrication in roll-to-plate or roll-to-roll modes. Those products based on nanostructured surfaces are, as described in author's earlier U.S. patent application Ser. No. 12/462,625 solar cells and panels, architectural glass windows, light emitting diodes (LEDs), flat panel displays, optical and magnetic storage disks, biosensors, and many other products.

There is a need to identify nanostructures produced using specific equipment and process in order to protect and enforce Intellectual Property (IP) rights, Thus some anti-counterfeiting features or systems should be developed and be embedded into a nanostructure seamlessly and non-intrusively. There are few mandatory requirements for such features/systems, among which are a) they should be quite difficult to find and/or replicate; b) they should be manufactured using mass production methods in order to keep added cost down, and c) due to increasing of counterfeiting industry sophistication, it is desirable to have a flexibility to change the anti-counterfeiting system frequently to avoid adoption of the method or system by the thieves.

### SUMMARY

Embodiments of the invention pertain to methods useful in anti-counterfeiting nanostructures produced using near-field optical lithography implemented with soft elastomeric masks. In particular, and by way of example only, anti-counterfeiting method may include specific micro- or nanostructures, in addition to the functional nanopattern, can be fabricated in elastomeric mask to create a code (array of artificially engineered point defects), which is replicated to the substrate material during nanostructuring.

This code can be then revealed upon interrogation of nanostructure with light sources, visual inspection or other surface analysis methods. Analogous micro- or nanostructures can be fabricated on the surface of the glass frame (cylinder or cone), thus to identify nanostructures produced using a specific tool. A specific code can be used to incorporate an array of “point defects” into the functional nanostructure itself. Such code can be just missing features over the area distributed according to a specific mathematical formula or small areas contained holographic optical element, which reveals a company logo or other image upon laser light interrogation. Alternatively multiple areas of nanostructures could be shifted one against another due to specific translation code. Obviously, all above anti-counterfeiting methods are applicable only to applications with high to moderate tolerance to point defects, like subwavelength anti-reflective coatings, self-cleaning coatings, light absorption layers in solar cells, light extraction layers in LEDs, and many others.

### BRIEF DESCRIPTION OF THE DRAWINGS

So that the manner in which the exemplary embodiments of the present invention are attained is clear and can be understood in detail, with reference to the particular description provided above, and with reference to the detailed description of exemplary embodiments, applicants have provided illustrating drawings. It is to be appreciated that drawings are provided only when necessary to understand exemplary embodiments of the invention and that certain well-known processes and apparatus are not illustrated herein in order not to obscure the inventive nature of the subject matter of the disclosure.

FIG. 1 shows a cross-sectional view of a near-field optical lithography mask described in WO2009094009.

FIG. 2 shows an overall opto-mechanical setup for “Rolling mask” near-field lithography

FIG. 3 shows a cross-sectional view of an embodiment, where specific micro- or nanostructure is fabricated on the surface of glass frame (cylinder)

FIG. 4 shows a cross-sectional view of another embodiment where specific micro- or nanostructure is fabricated on the surface of elastomeric film

FIG. 5 shows a cross-sectional view of another embodiment where the functional nanopattern fabricated on elastomeric surface has embedded features having a specific pattern and placement

FIG. 6 shows a cross-sectional view of another embodiment where the functional nanopattern fabricated on elastomeric surface has embedded features in the form of missing features

FIG. 7 shows a top down view of another embodiment where the functional nanopattern fabricated on elastomeric surface divided on areas of similar nanopattern shifted one against another with specific frequency and amplitude

### DETAILED DESCRIPTION OF EXEMPLARY EMBODIMENTS

As a preface to the detailed description, it should be noted that, as used in this specification and the appended claims, the singular forms “a”, “an”, and “the” include plural referents, unless the context clearly dictates otherwise.

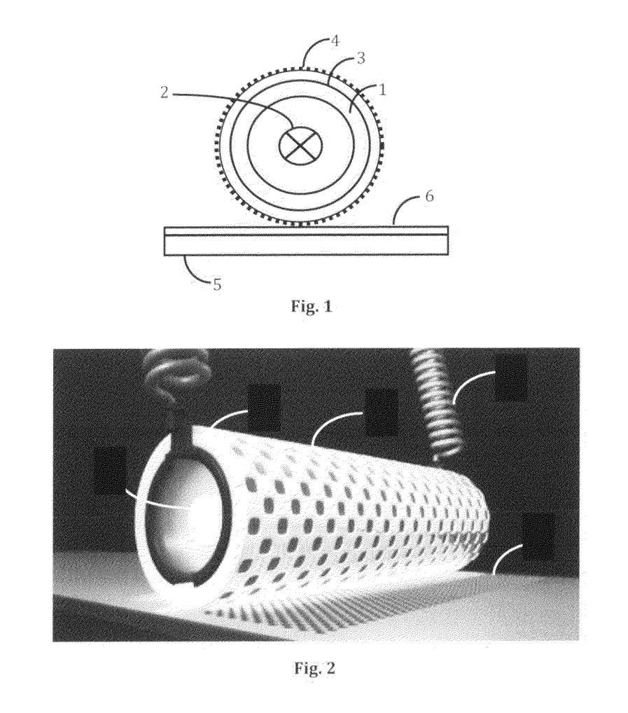

The authors have described a “Rolling mask” near-field nanolithography system earlier in WO2009094009. One of the embodiments is show in FIG. 1. The “rolling mask” consists of glass (quartz) frame in the shape of hollow cylinder 1. A light source 2, which can be a light bulb or array of LED sources, can be placed inside such cylinder or, alternatively, light source can be located outside cylinder and beamed inside and through the sidewall using optical system. A flexible film 3 laminated on the outer surface of the cylinder 1 has a nanopattern 4 fabricated in accordance with the desired pattern. Such film can be an elastomer, like Polydimethyl siloxane (PDMS), or other compliant polymer film. The mask is brought into contact with a substrate 5 coated with photosensitive material 6.

Nanopattern 4 can be designed to implement phase-shift exposure, and in such case is fabricated as an array of nanogroves, nanoposts or nanocolumns. Alternatively, a nanopattern can be fabricated as an array of nanometallic islands for plasmonic printing.

The overall view of the opto-mechanical system for near-field optical lithography is presented on FIG. 2, where cylinder 1 is suspended on springs 7. Alternative suspension mechanisms can be implemented as well (hydraulic, pneumatic or other).

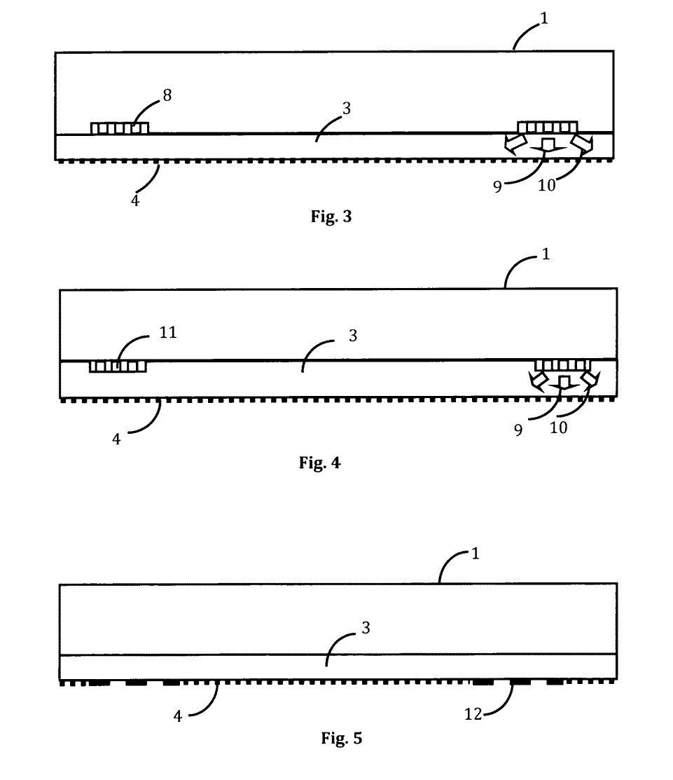

FIG. 3 represents an embodiment for anti-counterfeiting where some specific coded micro- or nano-patterned areas 8 fabricated in glass frame 1 are used to modify a functional nanopattern on the substrate. Such features could be, for example, a fragment of an optical grating having phase relief equal to it for a specific wavelength of the light source and refractive index of glass, thus to create 2 strong diffractive orders 10 (+/−1^{st} orders) and very weak O-th order 9. As a result, the nanopattern in specific places on the substrate would not be resolved properly, which will form coded a pattern recognizable in the product.

The density of such areas (defects) can be low such as not to degrade a performance of the nanostucture on the product. Alternatively, such areas of coded features could be placed in areas that do not affect the performance of a device or product in a significant way. In a rolling configuration, the defects will naturally be repeated and the repeat length is related to the cylinder diameter.

Such areas (defects) of coded features can also be either larger or smaller in comparison to a typical nanostructure size.

FIG. 4 shows another embodiment where such micro-or nanostructures 11 are formed on the surface of an elastomeric film 3. Again, low density of such micro- or nanostructures should not interfer significantly with the main nanostructure; alternatively, they are placed in areas, where their appearance is not affecting performance of the device.

FIG. 5 represent another embodiment where nanopattern 4 formed in elastomeric film 3 has designed to have a specific areas with different nanopattern 12 in predetermined places, which will form coded pattern recognizable in the product. Such coded nanopattern can be a company's logo, serial number or other an image or other information.

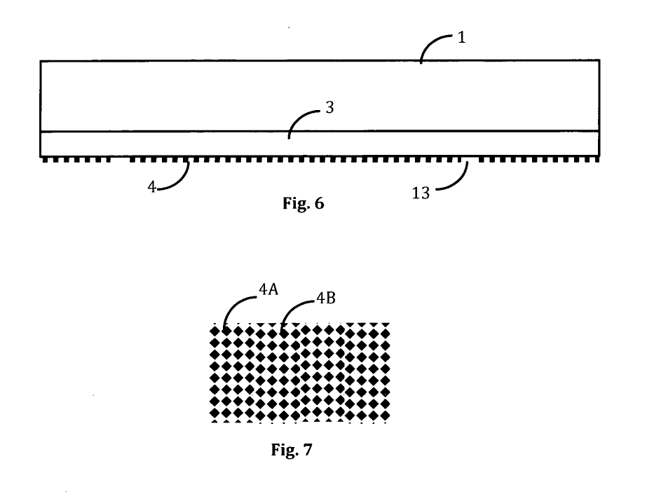

FIG. 6 shows yet another embodiment where such defects are just missing features 13 in the desired nanopattern 4, placed in specific places according to the code.

FIG. 7 shows another embodiment where nanopattern 4 is divided into multiple areas 4A and 4B of similar pattern but shifted according to the specific code.

Specific coded features can also be generated using modulation of light intensity or wavelength distribution along the mask length or width. This would create corresponding distribution of nano feature's geometry on the substrate surface (shape, height, pitch, etc.). This can be implemented using additional light sources to the main lithographic light source or specific. Alternatively, if the main light source is an array of light emitting diodes, specific light intensity distribution can be implemented using addressable power supply to individual diodes.

Specific coded features can also be generated using modulation of pressure between a mask and a substrate implemented using variations of elastomeric film thickness or programmed pressure variations during cylindrical mask rotation.

We claim:

1. A method of fabricating nanostructures having anti-counterfeiting features comprising:
a) providing a substrate having a radiation-sensitive layer on said substrate surface;
b) providing a rotatable mask having a nanopattern on an exterior surface of said rotatable mask;
c) providing a coded micro- or nanopattern in addition to said nanopattern of said rotatable mask
d) contacting said nanopattern with said radiation-sensitive layer on said substrate surface;
e) distributing radiation through said nanopattern, while rotating said rotatable mask over said radiation-sensitive layer, whereby a 2 sets of images are created in said radiation-sensitive layer, one is a main nanostructure image, and a second a coded anti-counterfeiting image

2. A method in accordance with claim 1, wherein said rotatable mask consists of a transparent cylinder or cone frame, and a flexible film is laminated on said rotatable mask frame.

3. A method in accordance with claim 2, wherein said coded micro- or nanopattern is fabricated on a said transparent cylinder or cone frame.

4. A method in accordance with claim 2, wherein said coded micro- or nanopattern is fabricated on a said flexible film

5. A method in accordance with claim 2, wherein said coded micro- or nanopattern is a diffractive optical element

6. A method in accordance with claim 2, wherein said coded micro- or nanopattern is a missing nano features on the said main nanopattern

7. A method of fabricating nanostructures having anti-counterfeiting features comprising:
a) providing a substrate having a radiation-sensitive layer on said substrate surface;
b) contacting said nanopattern with said radiation-sensitive layer on said substrate surface;
c) distributing radiation through said nanopattern, while rotating said rotatable mask over said radiation-sensitive layer,

8. A method in accordance with claim 7, wherein an intensity of such radiation is modulated along the width of said rotatable mask in accordance with a specific code

9. A method in accordance with claim 7, wherein a wavelength of such radiation is modulated along the width of said rotatable mask in accordance with a specific code

10. A method in accordance with claim 7, wherein a wavelength radiation is created using 2 or more light sources having different wavelength or intensity

11. A method in accordance with claim 7, wherein said rotatable mask consists of a transparent cylinder or cone frame, and a flexible film is laminated on said rotatable mask frame.

12. A method in accordance with claim 11, wherein said flexible film thickness is modulated along the mask widths or length in accordance with a specific code

13. A method in accordance with claim 11, wherein a contact pressure between said rotatable mask and a substrate is modulated during said rotating process in accordance with a specific code
